(19) United States
(12) Patent Application Publication
(10) Pub. No.: US 2021/0128372 A1
(43) Pub. Date: May 6, 2021

(54) ACCESSIBILITY VEHICLES

(71) Applicant: AVAN Mobility Inc, Winnipeg (CA)

(72) Inventor: Bryn Jones, Stonewall (CA)

(73) Assignee: AVAN Mobility Inc., Winnipeg (CA)

(21) Appl. No.: 17/091,914

(22) Filed: Nov. 6, 2020

Related U.S. Application Data
(60) Provisional application No. 63/070,298, filed on Aug. 26, 2020.
(60) Provisional application No. 62/931,524, filed on Nov. 6, 2019.

(51) Int. Cl. A61G 3/06; B60J 5/04; B62D 65/00

(52) U.S. Cl. CPC A61G 3/061; B62D 65/00; B60J 5/0497; B60J 5/0477

(57) ABSTRACT

An accessibility vehicle is for use with a vehicle and configured to move and stop on a surface. The vehicle is based upon a modified commercial vehicle having a side entrance and a floor. A bi-fold ramp module secured to the floor. The ramp module is positioned such that, in a folded configuration, the ramp module is substantially situated within the vehicle, and, in an extended configuration, the ramp module extends through the side entrance towards the surface to form a wheelchair ramp, the wheelchair ramp adapted for traverse in use by the wheelchair between the surface and the floor of the vehicle.

### CROSS-REFERENCE TO RELATED APPLICATIONS

This application claims priority to U.S. Provisional Patent Application Ser. Nos. 62/931,524 and 63/070,298, respectively filed Nov. 6, 2019 and Aug. 26, 2020.

### FIELD

The present invention relates to methods of modifying commercial vehicles into accessibility vehicles for use by handicapped individuals and ambulatory passengers.

### BACKGROUND

Wheelchair accessibility and mobility are ongoing issues. Accessible vehicles tend to be expensive.

### SUMMARY OF THE INVENTION

Forming one aspect of the present invention is an accessibility vehicle for use with a wheelchair and configured to move and stop on a surface. This accessibility vehicle comprises a modified commercial vehicle having a side entrance and a floor and a bi-fold ramp module secured to the floor. The ramp module is positioned such that: (i) in a folded configuration, the ramp module is substantially situated within the vehicle; and (ii) in an extended configuration, the ramp module extends through the side entrance towards the surface to form a wheelchair ramp, the wheelchair ramp adapted for traverse in use by the wheelchair between the surface and the floor of the vehicle.

Another aspect of the present invention is a method of modifying a commercial vehicle into an accessibility vehicle with a bi-fold ramp module, the vehicle configured for use with a wheelchair, configured to move and stop on a surface, and having a floor and sides, the ramp having a folded configuration and an extended configuration. This method comprises:
removing a portion of the side of the vehicle to create a side entrance;
removing a first section of the floor immediately adjacent the side entrance of the vehicle to create a first depression; and
installing the ramp module within the first depression, the ramp module being positioned such that:
   in the folded configuration, the ramp module is substantially situated within the vehicle; and
   in the extended configuration, the ramp module extends through the side entrance towards the surface to form a wheelchair ramp, the wheelchair ramp adapted for traverse in use by the wheelchair between the surface and the floor of the vehicle.

Forming another aspect of the present invention is apparatus comprising a vehicle and a bi-fold ramp. The vehicle has a rear entrance and a floor. The bi-fold ramp is secured to the vehicle such that:
in a folded configuration, the ramp is situated within the vehicle, and
in an extended configuration, the ramp extends through the rear entrance to rest on a curb or ground exterior to the vehicle.

Another to yet another aspect of the present invention is a method for use with a vehicle and a bi-fold ramp, the vehicle having a floor and a rear, the ramp having a folded configuration and an extended configuration. This method comprises:
constructing a rear entrance in the rear of the vehicle;
removing a section of the floor immediately adjacent the rear of the vehicle to create a void; and
installing the ramp within the void in the floor such that:
   in the folded configuration, the ramp is situated within the vehicle, and
   in the extended configuration, the ramp extends through the rear entrance to rest on a curb or ground exterior of the vehicle.

### BRIEF DESCRIPTION OF THE DRAWINGS

The present invention will now be described by way of example only with reference to the following drawings in which:

FIG. 1 is a side perspective view of an unmodified commercial vehicle.

FIG. 2 is an enlarged view of portion A of FIG. 1.

FIG. 3 is a view of FIG. 2 with a portion of the side and portions of the floor of the vehicle removed.

FIG. 4 is a view of FIG. 3 with a floor support and door frame installed.

FIG. 5 is a view of a ramp in isolation in a folded configuration.

FIG. 6 is a view of the ramp of FIG. 5 in an extended configuration.

FIG. 7 is a view of the vehicle of FIG. 4 with the ramp of FIG. 6 installed, and the double leaf doors installed.

FIG. 8 is an enlarged view of portion B of FIG. 7 with a transition pan installed and the ramp in an extended configuration.

FIG. 9 is a plan view of the accessibility vehicle of FIG. 8.

FIG. 10 is a cross-sectional view of FIG. 9 along line 10-10.

FIG. 11 is view of portion C of FIG. 9 in use with a wheelchair before it encounters the ramp.

FIG. 12 is view of FIG. 11 when the wheelchair is on the ramp.

FIG. 13 is view of FIG. 12 when the wheelchair has left the ramp and entered the vehicle.

FIG. 14 is a view of FIG. 8 with the ramp in a folded configuration and the double leaf doors in an open position.

FIG. 15 is a view of the modified vehicle of FIG. 14 with the double leaf doors in a closed position.

FIG. 16 is a rear view of a prior art vehicle.

FIG. 17 is a view of the vehicle of FIG. 16, with the rear doors opened.

FIG. 18 is a view of a prior art bifold ramp in a closed configuration.

FIG. 19 is a view of the ramp of FIG. 18 in an extended configuration.

FIG. 20 is a view of a portion of the vehicle of FIG. 16.

FIG. 21 is a view similar to FIG. 20, with the wheel removed.

FIG. 22 is a view similar to FIG. 21, with the wheel carrier removed.

FIG. 23 is a view similar to FIG. 22, with the spindles removed to reveal the spindle supports.

FIG. 24 is a view of an adapter plate.

FIG. 25 is a view similar to FIG. 23 with the spindle support removed and the plate of FIG. 24 mounted to the axle brackets.

FIG. 26 is a view similar to FIG. 25 with spindle support mounted to the adapter plate and the spindle mounted to the spindle support.

FIG. 27 is a view similar to FIG. 25 with the wheel and fender in position.

FIG. 28 is a view of wheel wells according to another embodiment of the invention

FIG. 29 is a view of the vehicle of FIG. 16 with the rear doors and a portion of the floor removed and a frame secured in place.

FIG. 30 is an enlarged view of a portion of FIG. 29

FIG. 31 is a view of the underside of FIG. 29

FIG. 32 is a further enlarged view of a portion of FIG. 29

FIG. 33 is a view similar to FIG. 29, with steel secured in place.

FIG. 34 is a view of the structure of FIG. 33, from the inside of the vehicle.

FIG. 35 is a view similar to FIG. 33 with the double leaf doors installed.

FIG. 36 is a view of the interior of the structure of FIG. 35.

FIG. 37 is a rear exterior view of the structure of FIG. 35, with the double leaf doors open.

FIG. 38 is a view similar to FIG. 37 with the ramp extended.

FIG. 39 is an interior view of the structure of FIG. 38.

FIG. 40 is a side, partial cross-sectional view of the structure of FIG. 38.

FIG. 41 is a view similar to FIG. 41 with the ramp retracted.

FIG. 42 is a partially cut-away plan view of the structure of FIG. 38 in use.

FIG. 43 is a partially cut-away plan view of the structure of FIG. 38 in use.

FIG. 44 is a view of another embodiment of the invention, showing a portion of a vehicle having a side entry door similar to that shown in FIG. 8 and a ramp in a retracted position.

FIG. 45 is a view of the structure of FIG. 44, with the ramp in an extended position.

### DETAILED DESCRIPTION

### Side Access Bifold Embodiment

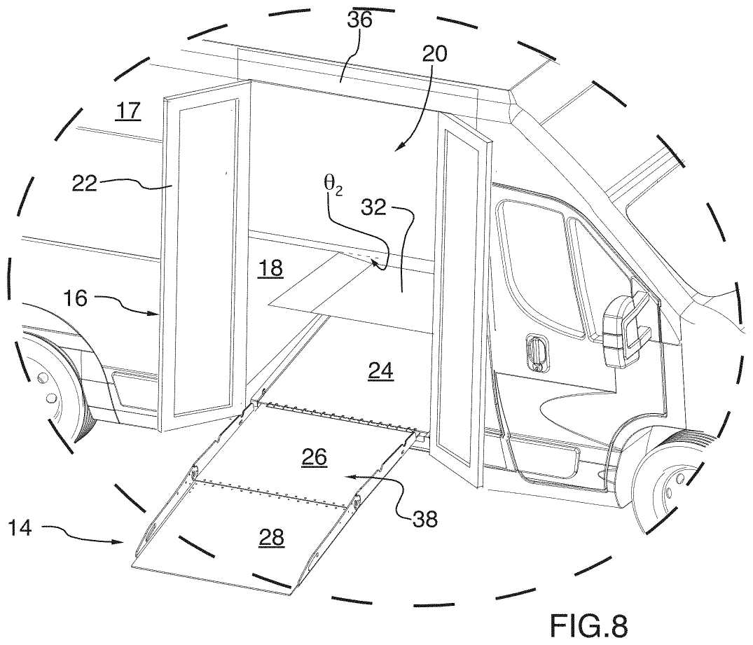

Referring to FIGS. 8-10 and 14-15, there is shown an example of an accessibility vehicle 10. Accessibility vehicle 10 is for use with a wheelchair 102, is configured to move and stop on a surface 200 and includes a modified vehicle 12, a bi-fold ramp module 14, and access doors 16.

Modified vehicle 12 has a floor 18 and a side entrance 20 in a side 17 of the vehicle that is positioned beside and behind the passenger side door. In the depicted embodiment, the vehicle is a standard light commercial vehicle, and more specifically, a Ram Promaster®. As depicted, modified vehicle 12 (i.e. a modified Ram Promaster®) has an interior height of 76 inches and an interior width of approximately 56 inches at the wheel well and 62 inches at the side panel. Overall, vehicle 12 has an internal volume of approximately 420 cubic feet and a load floor height (i.e. the height at which a load is maintained above the ground) of approximately 21 inches.

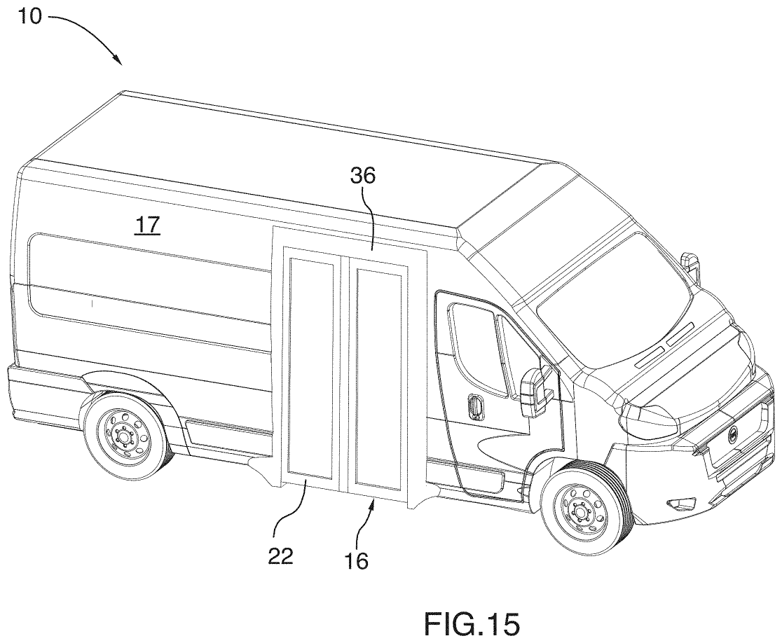

Bi-fold ramp module 14 in the depicted embodiment comprises a ramp pan 24, a first extension panel 26, and a second extension panel 28, secured together with hinges 30. See FIGS. 8 and 15 for example. Ramp module 14 is moveable between a folded configuration (FIG. 8), where all three segments 24, 26, 28, are stacked on top of one another in a Z-shape, and an extended configuration (FIG. 15), where all three segments 24, 26, 28, are spread apart. In the present embodiment, for use with the Ram Promaster®, ramp module 14 is the BF3462Y-2 model of the RA300 Transit Ramp manufactured by BraunAbility®. The BF3462Y-2 model has a usable width of approximately 34 inches, a usable length of approximately 95 inches and a carrying capacity of 1,000 lbs. In the folded configuration, ramp module 14 is approximately 38 inches wide by 33 inches long. In the extended configuration, ramp module 14 is approximately 38 inches in width by 95 in length.

In the embodiment shown, ramp module 14 has a metal, such as aluminum, construction with a metal housing, such as stainless steel, with a welded box design to provide for rigidity. It also has a continuous slip-resistant surface, and a baked-on powder coating to provide for corrosion resistance. The frame design provides rigidity for ramp alignment and ramp operation. Ramp module 14 has been tested to a minimum static load of 1980 pound and has a 1000 pound rated capacity.

The ramp's power unit uses a hydraulic pump module that uses a voltage of 12 VDC and a maximum current of 30 amps for automatically folding and unfolding ramp module 14. Its power supply includes a self-contained 12 volt electric hydraulic system operating two bi-directional cylinders that do not require dependence on the vehicle's hydraulic systems. The hydraulic power pack system is of a modular design and the power operation of the hydraulic cylinders is a push-pull design. Ramp module 14 has a gravity-down feature to prevent vehicle jacking upon deployment, and ramp pinching upon stowage. Ramp module 14 also employs a pressure relief system to limit its ability to raise more than 50 pounds.

Ramp module 14 includes a manual back-up system for ensuring operation of ramp module 14 in case of electrical failure. The back-up system includes means, such as hand grips, to manually stow and deploy ramp module 14.

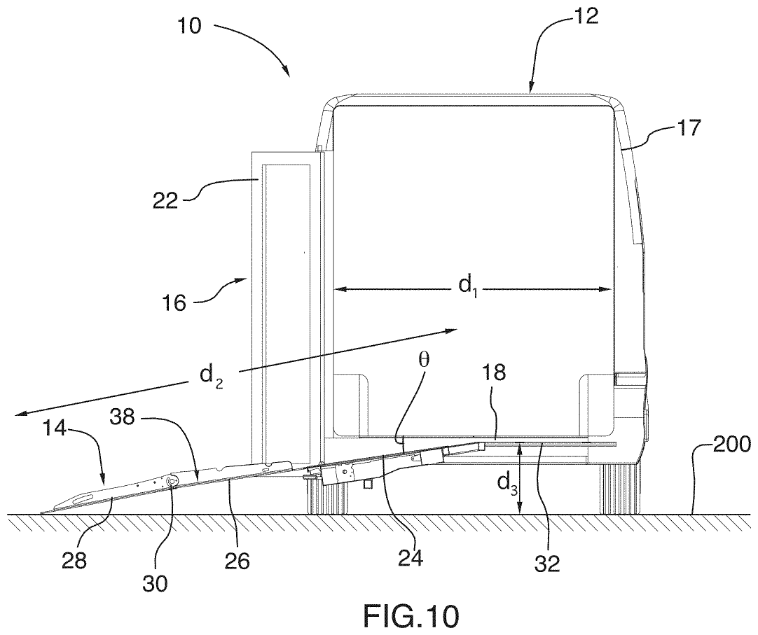

Ramp module 14 is positioned within vehicle 12. In particular, as shown, ramp module 14 is secured immediately adjacent side entrance 20. Ramp module 14 is positioned relative to floor 18 at a downward ramp angle θ₁ to floor 18. In particular, the ramp angle θ₁ shown is around 9.5 degrees from floor 18, as indicated in FIG. 10. Ramp module 14 is also positioned below floor 18 such that ramp module 14 extends below floor 18. In particular, ramp module 14 is secured about 1.75 inches below floor 18 from its highest point when ramp module 14 is stowed within vehicle 12.

Ramp pan 24 is positioned such that the entire ramp pan 24 is situated within vehicle 12. In this manner, when the bi-fold ramp module is in the folded configuration, all three segments 24, 26, 28 are stacked and situated within vehicle 12. When the bi-fold ramp module is in the extended configuration, first and second extension panels 26, 28 extend through side entrance 20 towards surface 200 to form a wheelchair ramp 38.

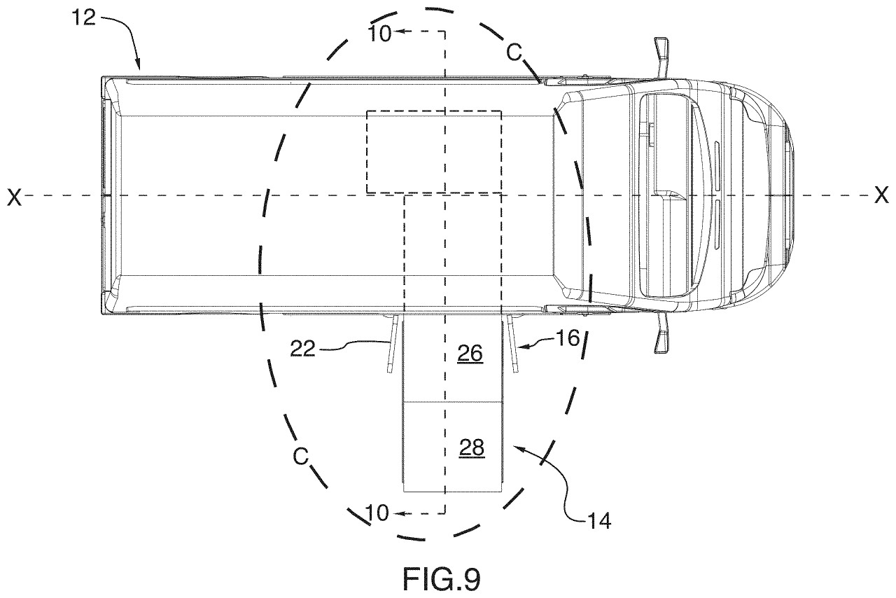

As shown, three segments 24, 26, 28 are positioned approximately 180 degrees relative to one another. Hinges 30, however, allow segments 24, 26, 28 to rotate past 180 degrees. As well, the direction of ramp module 14, when extended, is perpendicular to a longitudinal axis X-X of floor 18 (see FIG. 9 for example).

Accordingly, the dimensional ratio of the internal width of vehicle 12 (d₁) to the length ramp module 14 in the extended configuration (d₂) to the distance from surface 200 to floor 18 of the vehicle (d₃) is approximately 6:9:2. See FIG. 10 for example. In the present example, therefore, d₁:d₂:d₃ is approximately 62:95:21 inches. Given the above noted dimensions of vehicle 12 and ramp module 14, and their orientation relative to one another, wheelchair ramp 38 is adapted for traverse in use by wheelchair 102 between surface 200 and floor 18 of vehicle 12.

Access doors 16 in the depicted embodiment are double leaf doors 22. Double leaf doors 22 operatively cover side entrance 20 above ramp module 14.

The depicted embodiment of accessibility vehicle 10 further comprises a transition pan 32. Transition pan 32 is shown positioned to span ramp pan 24 and floor 18 and is secured below floor 18 by 1.25 inches. In the depicted embodiment, transition pan 32 is orientated largely parallel to floor 18.

While one embodiment of accessibility vehicle 10 is described, variations are possible. For example, rather than a Ram Promaster®, vehicle 12 may be a Fiat Ducato, a Peugeot Boxer, a similar L4H2 (Length 4, Height 2) vehicle, such as a Ford Transit, and Mercedes Sprinter, or another vehicle with a GVWR (Gross Vehicle Weight Rating) between 8,000 lbs and 13,000 lbs that is commercially available on the market.

In other applications, vehicle 12 would have an interior height between 56 and 81 inches, and an interior width between 38 and 74 inches. The vehicle would also preferably have an internal volume between 250 and 500 cubic feet and a load floor height of at least 19 inches.

Rather than the BF3462Y-2 model of the Transit Ramp manufactured by BraunAbility®, ramp module 14 may be a different ramp that can be folded into the vehicle and unfolded to extend outside the vehicle, so long as that ramp can accommodate and structurally support a handicapped individual in a wheelchair.

In that regard, rather than a ramp with dimensions of 38 inches by 33 inches long while folded, the usable width of ramp module 14 may be 26 to 44 inches wide, and/or 27 to 40 inches long when folded. As well, in the extended configuration, the useable portion ramp module 14 may be 26 to 44 inches wide, and/or 30 to 120 inches long, thus forming a wheelchair ramp having a length between 30 to 120 inches long.

The angle at which ramp module 14 is secured to floor 18, the distance at which ramp module 14 is secured below floor 18, and the angle from which ramp module 14 extends from vehicle 12, may be varied. For example, rather than the ramp angle of around 9.5 degrees from floor 18, ramp module 14 may be secured at an angle of 0 to 15 degrees from floor 18, so long as ramp module 14 can extend towards surface 200 to form wheelchair ramp 38. And rather than 1.75 inches below floor 18 when ramp module 14 is stowed, ramp module 14 may be secured 0 to 12 inches below floor 18 from its highest point. As well, rather than extending perpendicular from the longitudinal axis X-X of floor 18, the angle by which ramp module 14 may extend from the longitudinal axis of floor 18 may be between 45 to 135 degrees.

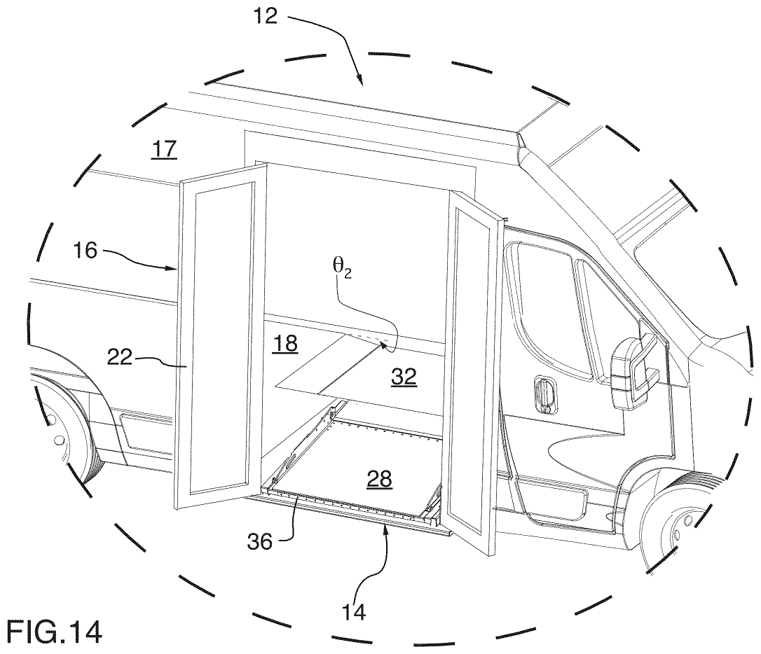

In other applications, rather than being positioned generally parallel to floor 18, transition pan 32 may be positioned at a transition angle θ₂ to floor 18 (see FIGS. 8 and 14 for example). In that regard, the transition angle to floor 18 may be 10 degrees. In this manner, since ramp module 14 is also secured below floor 18, transition pan 32 forms a bridge to smoothly connect ramp pan 24 of ramp module 14 with the rest of floor 18. In other examples, transition pan 32 may be secured at a transition angle between 0 to 10 degrees. In some examples, the transition angle may be smaller than the ramp angle.

Rather than double leaf doors 22, accessibility vehicle 10 may involve a single leaf door, or a different door, so long as the doors do not interfere with the operation and storage of ramp module 14 in either of its configurations.

While the illustrated embodiment includes a side entrance 20 that is positioned proximate/adjacent to the passenger door of vehicle 12, side entrance 20 may be positioned closer to the passenger side rear wheel of vehicle 12. In yet other examples, side entrance 20 may instead by positioned on the other side of vehicle 12, i.e. on the driver side of vehicle 12. In a similar manner as described above, side entrance 20 may, thus, also be positioned adjacent the driver side door, adjacent the driver side rear wheel, or somewhere in between. Such a variation may allow for a larger interior usable space within vehicle 12.

As noted above, ramp pan 24 of the depicted embodiment is entirely positioned and secured to floor support 34 within vehicle 12. In an alternate application, rather than be entirely situated within vehicle 12, ramp module 14 may be substantially situated within vehicle 12. In that regard, ramp pan 24 may be secured to floor support 34 such that a portion of ramp pan 24 extends outside of modified vehicle 12. For example, the lower end of ramp pan 24 may extend past sidewall 17 of modified vehicle 12. To accommodate this variation, door frame 36 may also be modified to extend further from sidewall 17 to generally the same distance. In this manner, access doors 16 or double leaf doors 22 can still operatively cover and provide a seal around side entrance 20 above ramp module 14. Such a variation may allow for a larger interior usable space within vehicle 12.

In further applications, accessibility vehicle 10 may include a kneeling device (not shown). The kneeling device enables side 17 of modified vehicle 12 to be lowered in order to decrease its load height and/or decrease wheelchair ramp's 38 distance from surface 200.

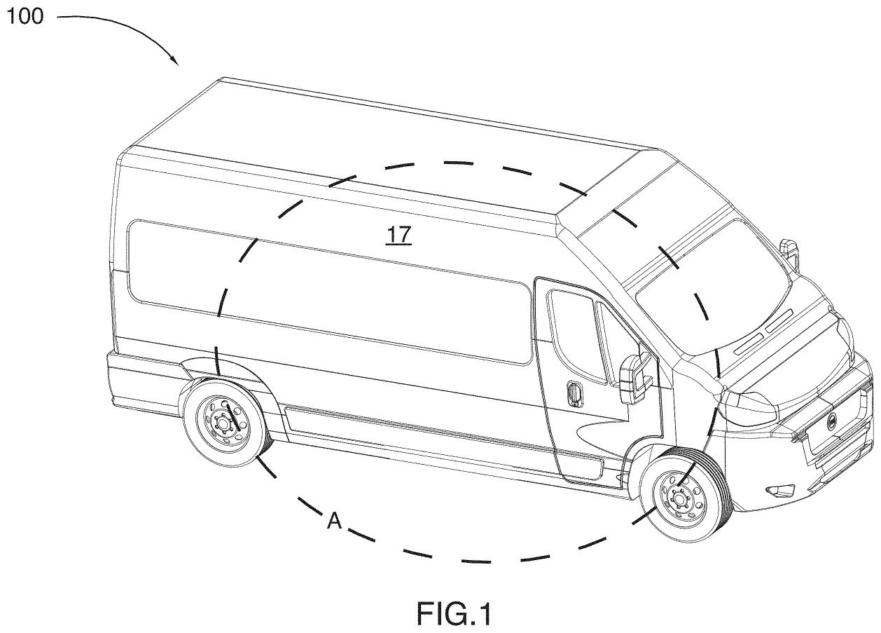

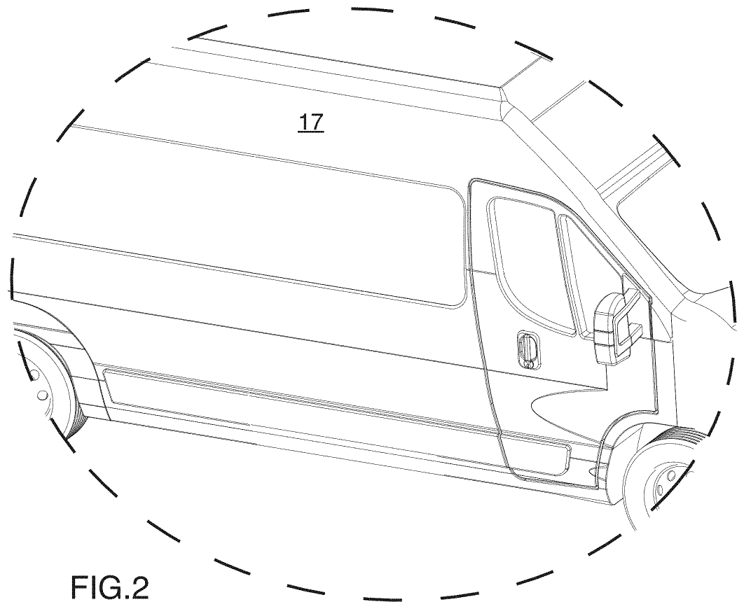

Referring to FIGS. 1-8, there is shown an example method of modifying a standard commercial vehicle 100, with a GVWR between 8,000 lbs and 13,000 lbs, into accessibility vehicle 10. As shown in FIG. 1, for example, any vehicle with a GVWR between 8,000 lbs and 13,000 lbs may be used, so long as the vehicle has a floor 18, sides 17, an internal volume of at least 250 cubic feet, sufficient to hold at least one individual with a wheelchair, and a load floor height of at least 19 inches.

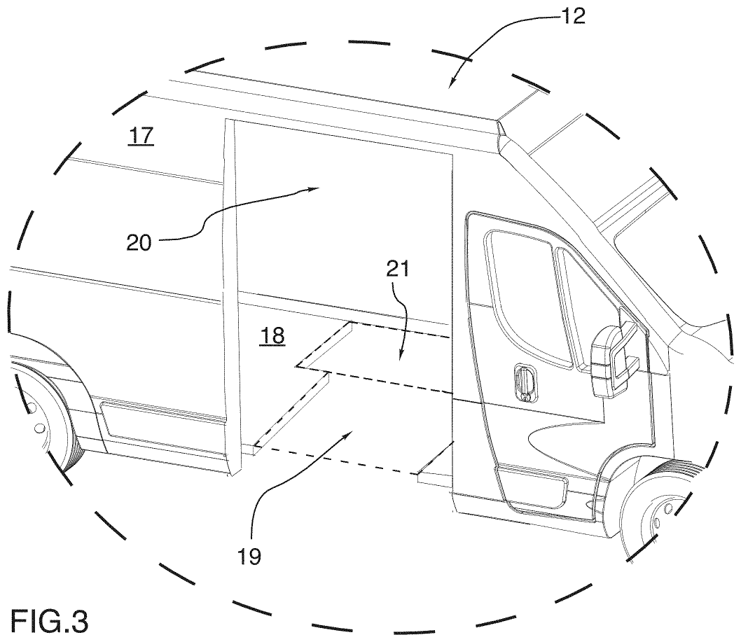

As a first step, a portion of side 17 of vehicle 100 is removed to form side entrance 20, as shown in FIG. 3.

The next step is to remove a first section of floor 18 that is adjacent or immediately interior to side entrance 20 to create a first opening or depression 19. First opening 19 is indicated by dashed lines in FIG. 3. As depicted, the first section is about 37 inches wide by 39 inches long, thus making up approximately 14 percent of floor 18. As also shown in FIG. 3, a second section of floor 18 may also be removed from floor 18 to create a second opening or depression 21. The second section is positioned adjacent first depression 19 further away from side entrance 20 such that first depression 19 is positioned between second depression 21 and side entrance 20. The second section may be about 30 inches wide by 47 inches long.

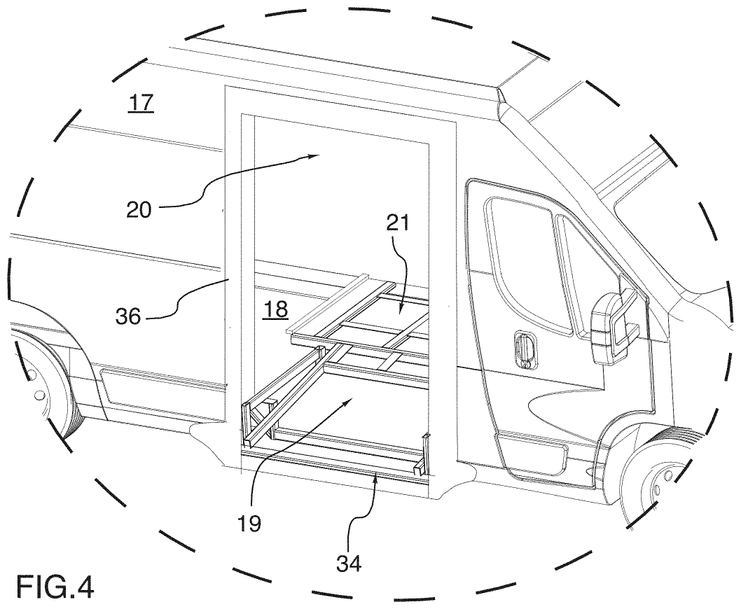

A floor support 34 structure is then installed in first and second depressions 19, 21 to floor 18 as shown in FIG. 4. A door frame 36 may also be installed around side entrance 20.

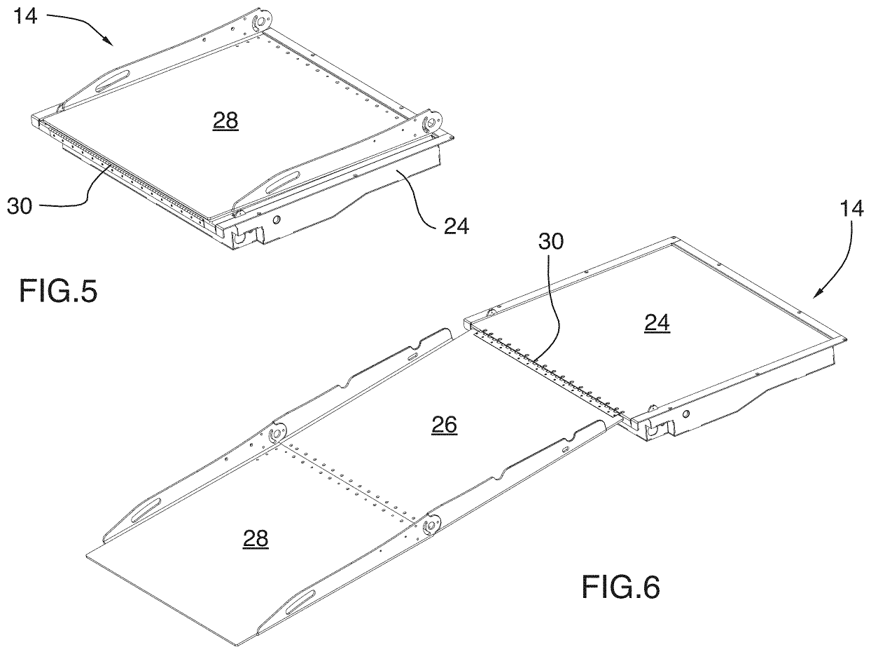

Ramp module 14 is installed or secured to modified vehicle 12 within first depression 19 of floor 18 over floor support 34. In the depicted embodiment, a bi-fold ramp (see FIGS. 5 and 6) is installed within vehicle 12. In particular, ramp pan 24 is directly secured within depression 19 of floor 18. Ramp pan 24 is situated within vehicle 12 and is also aligned with side entrance 20.

Accordingly, the dimensional ratio of the internal width of vehicle 12 (d₁), to the length ramp module 14 in the extended configuration (d₂) or the length of wheelchair ramp 38, to the distance from surface 200 to floor 18 of the vehicle (d₃) or the load floor height, is approximately 6:9:2. [See FIG. 10]. In the present example, therefore, d₁:d₂:d₃ is approximately 62:95:21 inches.

Positioned in this manner, ramp module 14 will be situated within vehicle 12 when ramp module 14 is in the Z-shaped folded configuration. When ramp module 14 is in the extended configuration, first and second extension panels 26, 28 extend through side entrance 20 towards surface 200 to form wheelchair ramp 38. Thus configured, wheelchair ramp 38 is adapted for traverse in use by wheelchair 102 between surface 200 and floor 18 of vehicle 12.

Ramp module 14 is further installed such that, when extended, it extends perpendicular to a longitudinal axis X-X of floor 18, as shown in FIG. 9.

Ramp module 14 is also secured at an angle to floor 18, below the surface of floor 18, thus extending downwardly away from floor 18. As depicted, ramp module 14 is installed so as to have a slope of 1:4, or less, relative to surface 200 when in its extended configuration. In particular, ramp module 14 is secured at a ramp angle θ₁ of around 9.5 degrees from the surface of floor 18. Ramp module 14 is also secured at least 1.75 inches below floor 18 from its highest point when ramp module 14 is stowed in vehicle 12.

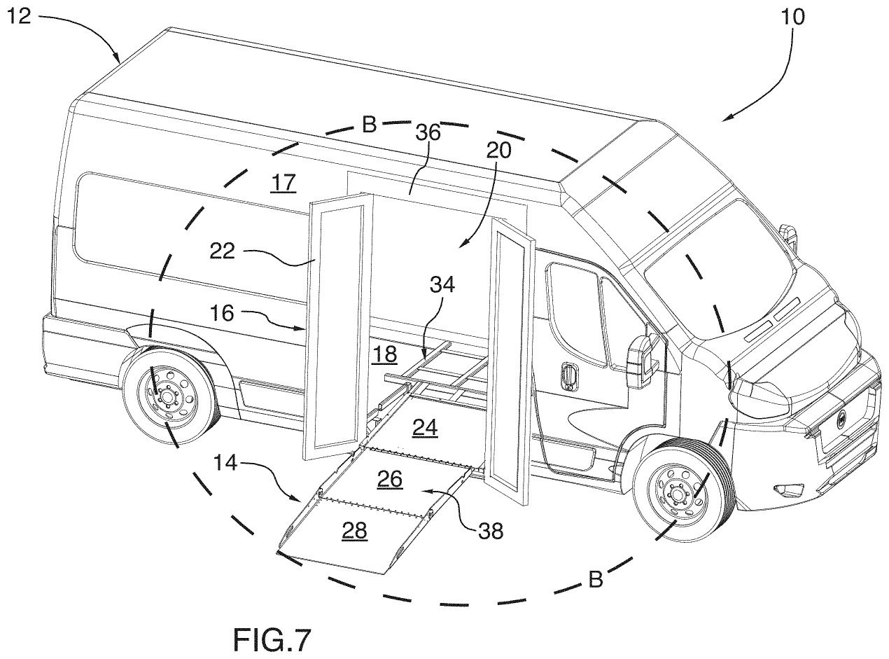

After ramp module 14 is installed, double-leaf doors are installed to operatively cover side entrance 20, as indicated by FIG. 7.

Transition pan 32 is then installed into second depression 21 of floor 18 over floor support 34. See FIG. 8. Transition pan 32 is intended to bridge ramp module 14 and floor 18, and is secured generally parallel to floor 18, approximately 1.25 inches below floor 18.

While one embodiment of a method of modifying a commercial vehicle 100 into accessibility vehicle 10 is described, variations are possible. For example the removal of the second section of floor 18 is optional, and may not be performed. In such a case, accessibility vehicle 10 may not include transition pan 32 at all.

In other examples, while first depression 19 is shown to form approximately 14 percent of floor 18, in alternate applications, first depression 19 may form approximately 10-50 percent of floor 18, or have dimensions different from those noted above. Second section/depression may also have different dimensions than 30 inches wide by 47 inches long as noted above.

The ramp angle at which ramp module 14 is secured to floor 18, and the distance at which ramp module 14 is secured below floor 18 may also be varied. For example, rather than the ramp angle being around 9.5 degrees from floor 18, ramp module 14 may be secured at ramp angle of 0 to 15 degrees from floor 18, so long as ramp module 14 can extend towards surface 200 to form wheelchair ramp 38. And rather than 1.75 inches below floor 18, ramp module 14 may be secured 0 to 12 inches below floor 18 from its highest point.

As well, rather than being installed such that ramp module 14 extends perpendicular from the longitudinal axis X-X of floor 18, ramp module 14 may be installed such that the angle by which ramp module 14 extends from the longitudinal axis X-X of floor 18 may be between 45 to 135 degrees.

In other applications, rather than being orientated parallel to floor 18, transition pan 32 may be secured at a transition angle θ₂ to floor 18, such as 10 degrees, to extend downwardly from floor 18. In other examples, transition pan 32 may be secured within second depression 21 at a transition angle θ₂ between 0 to 10 degrees. In some examples, the transition angle may be smaller than the ramp angle.

In another example, rather than double leaf doors 22, a single leaf door, or a different door may be installed to operatively cover side entrance 20, so long as the doors do not interview with the operation and storage of ramp module 14 in either of its configurations.

As well, while the described embodiment includes removing a portion of the passenger side sidewall 17 proximate the passenger side door of vehicle 12 to form side entrance 20, a different portion of the passenger side sidewall 17 may be removed instead. For example, a portion of the sidewall adjacent the passenger side rear wheel may be removed. In another example, a portion of the driver side sidewall may be removed to form side entrance 20.

As noted above, ramp pan 24 may be positioned and secured to floor support 34 entirely within vehicle 12. In an alternate application, rather than be entirely situated within vehicle 12, ramp module 14 may be secured so as to be substantially situated within vehicle 12. In that regard, ramp pan 24 may be secured to floor support 34 such that a portion of ramp pan 24 extends outside of modified vehicle 12. For example, ramp pan 24 may be installed within the first depression such that the lower end of ramp pan 24 extends past sidewall 17 of modified vehicle 12. To accommodate this variation, door frame 36 may also be modified and installed to extend further from sidewall 17 to generally the same distance that ramp pan 24 extends past sidewall 17. In this manner, access doors 16 or double leaf doors 22 can still operatively cover and provide a seal around side entrance 20 above module 14.

The method may further include installing a kneeling device onto vehicle 12. The kneeling device enables side 17 of modified vehicle 12 to be lowered in order to decrease its load height and/or decrease the ramp's angle to surface 200.

In other applications, the order in which the components are installed may be different. For example, rather than installing the ramp first, the transition ramp may be first installed before the ramp and the double leaf doors are installed.

Given the above described vehicle and method, a standard commercial vehicle may be modified into an accessibility vehicle which would have sufficient space to transport a small number of handicapped individuals using wheelchairs or ambulatory passengers.

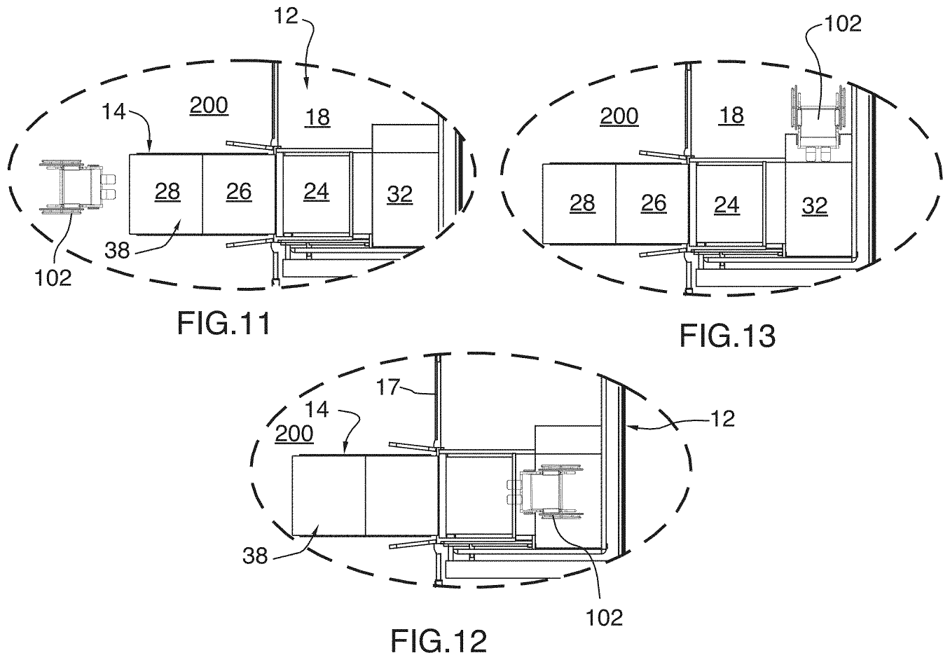

Turning to FIGS. 8-15, for example, when a handicapped or ambulatory individual wishes to be transported somewhere, accessibility vehicle 10 pulls up, double leaf doors 22 open and ramp module 14 can be extended into its extended configuration towards surface 200 to form wheelchair ramp 38 (see FIGS. 8 and 11).

Ramp module 14, in turn, is sufficiently dimensioned and constructed to allow a wheelchair 102, or another carrier with wheels, to then travel from surface 200 up along wheelchair ramp 38, over transition pan 32 (see FIG. 12), onto floor 18 and into accessibility vehicle 10 (see FIG. 13). Once the individual has entered accessibility vehicle 10, ramp module 14 may be folded into its folded configuration (see FIG. 14) and be fully or substantially seated within accessibility vehicle 10. Double leaf doors 22 can then close, and the accessibility vehicle 10 can travel to its next destination (see FIG. 15).

Upon arrival at the destination, double leaf doors 22 open, and ramp module 14 can be extended into its extended configuration towards surface 200 to form wheelchair ramp 38. Wheelchair 102 may then traverse, from floor 18, onto transition pan 32, down wheelchair ramp 38, and onto surface 200 exterior to vehicle 12.

### Rear Access Embodiments

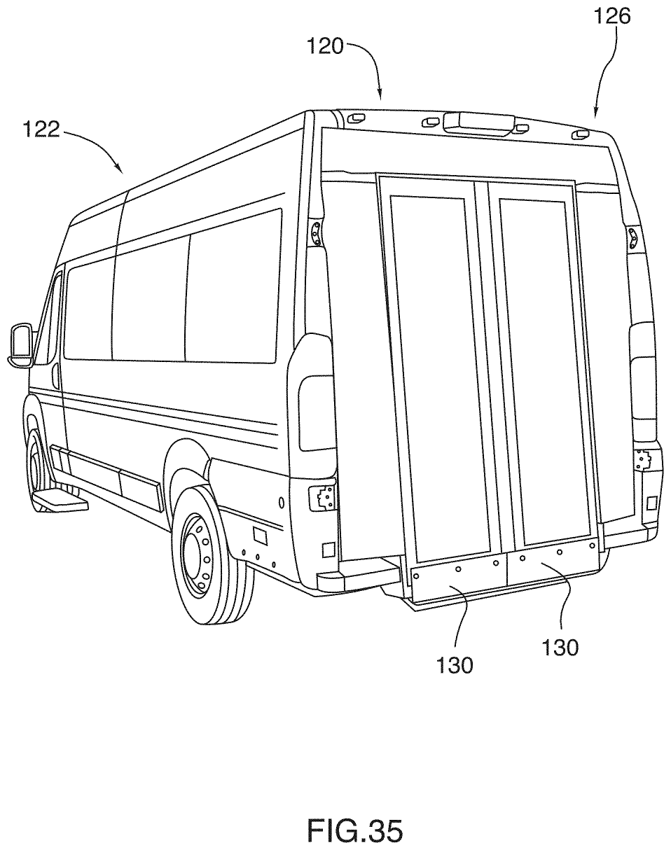

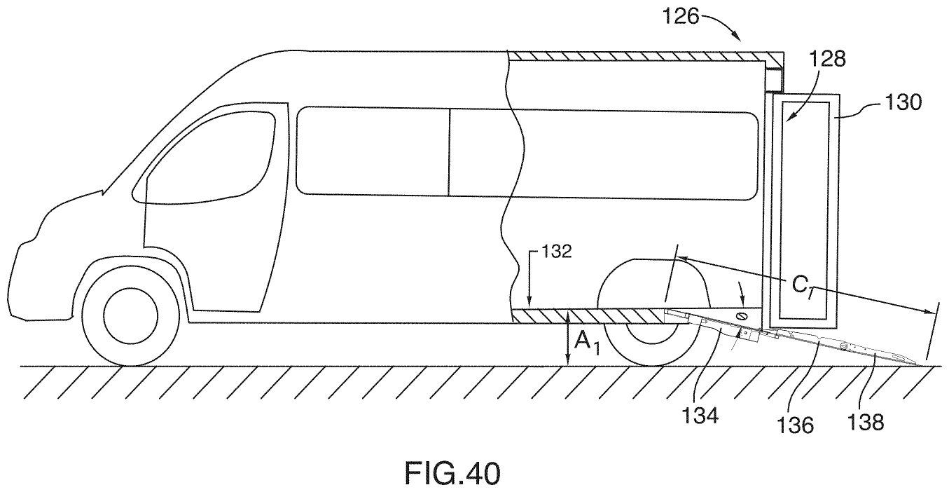

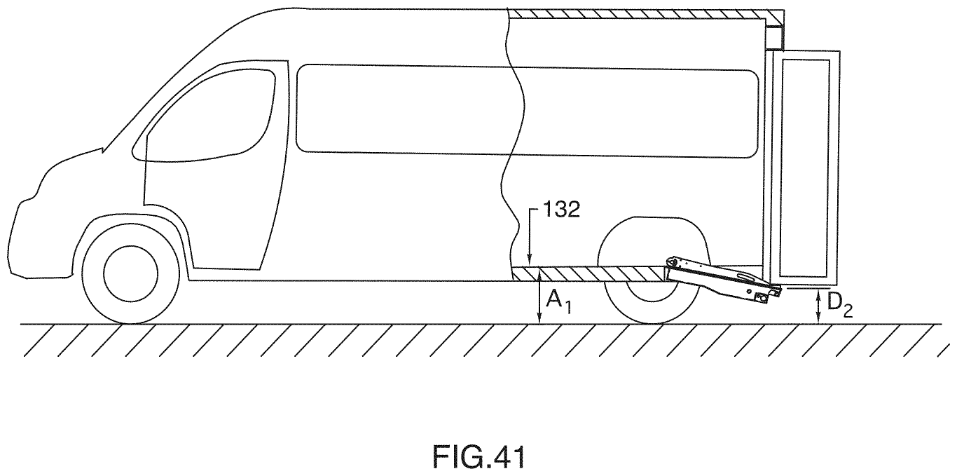

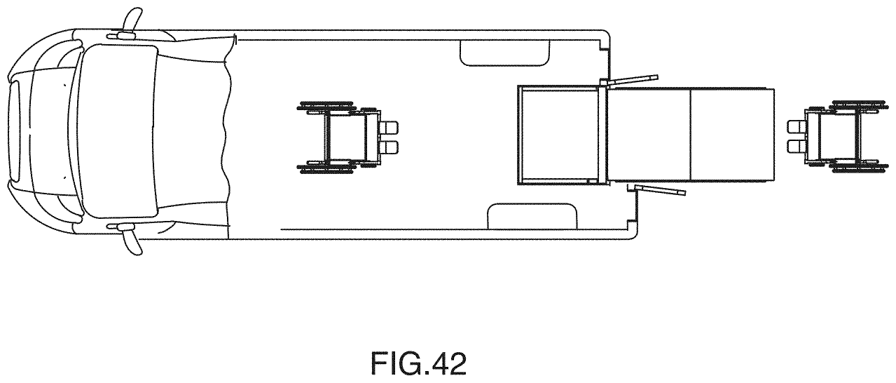

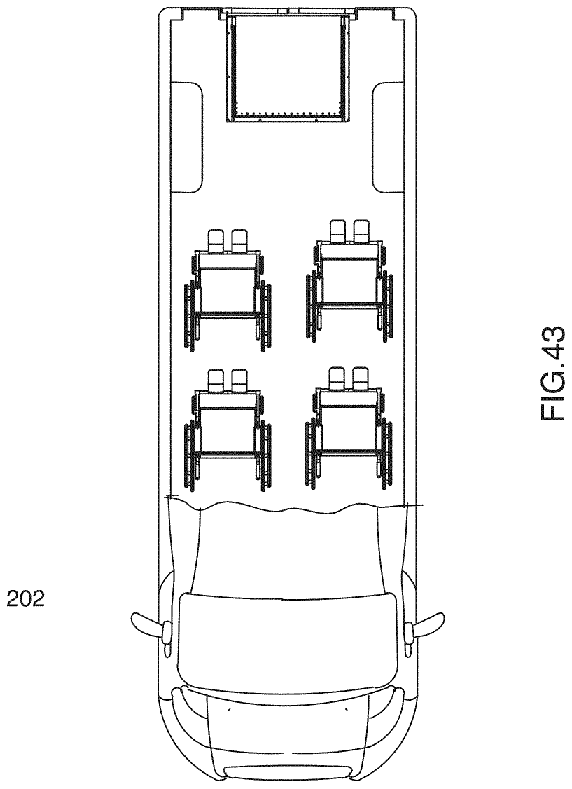

Referring to FIGS. 35-43 there is shown an embodiment 120 of the invention comprising a vehicle 122 and a bi-fold ramp 124.

Vehicle 122 has a rear 126 defining an entrance 128, access doors 130 and a floor 132. Access doors 130 in the depicted embodiment are double leaf doors 130 operable to selectively occlude entrance 128.

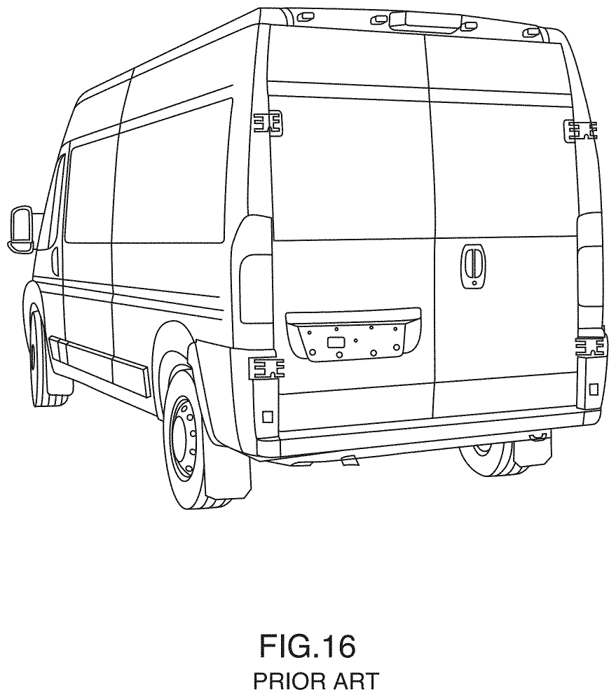

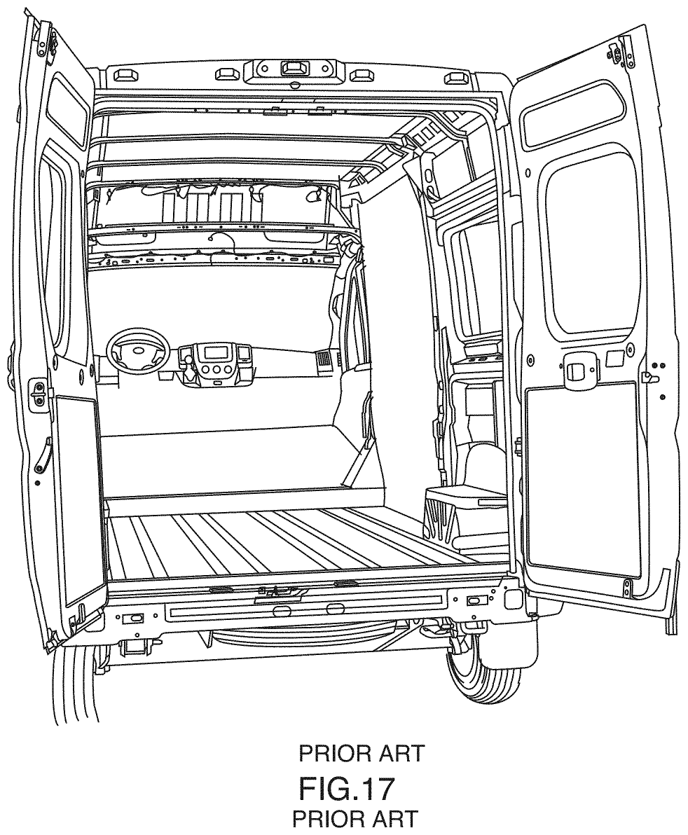

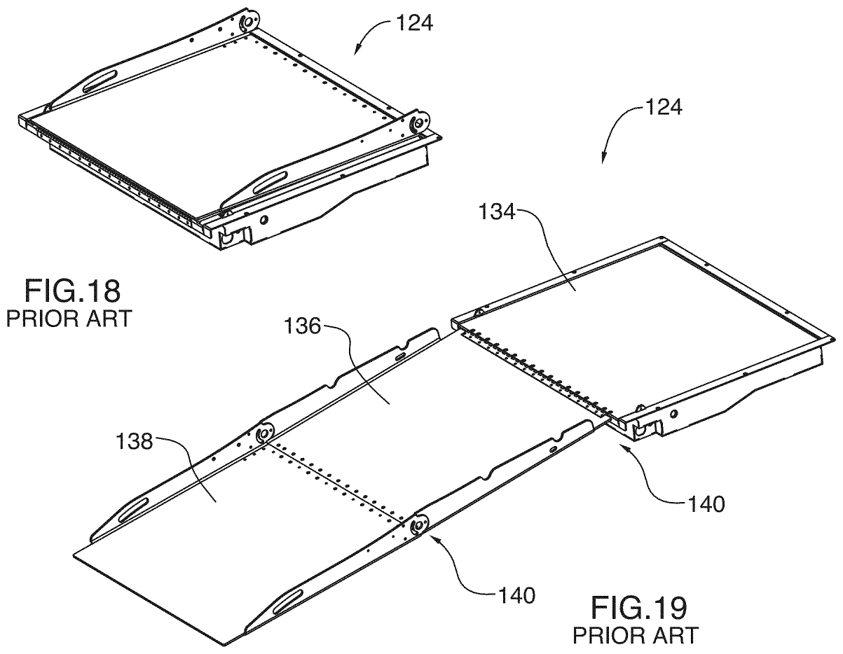

In the depicted embodiment, the vehicle 122 is a based upon the Ram Promaster® shown in isolation in FIG. 16 and FIG. 17.

Vehicle 122 has an interior height of 176 inches, an interior width of approximately 58.5 inches at the rear wheel well, an anterior width of 69 inches at the side panel, an internal volume of approximately 420 cubic feet and a load floor height A1 of approximately 26.5 inches.

Bi-fold ramp 124 in the depicted embodiment comprises a ramp pan 134, a first extension panel 136 and a second extension panel 138, all secured together with hinges 140.

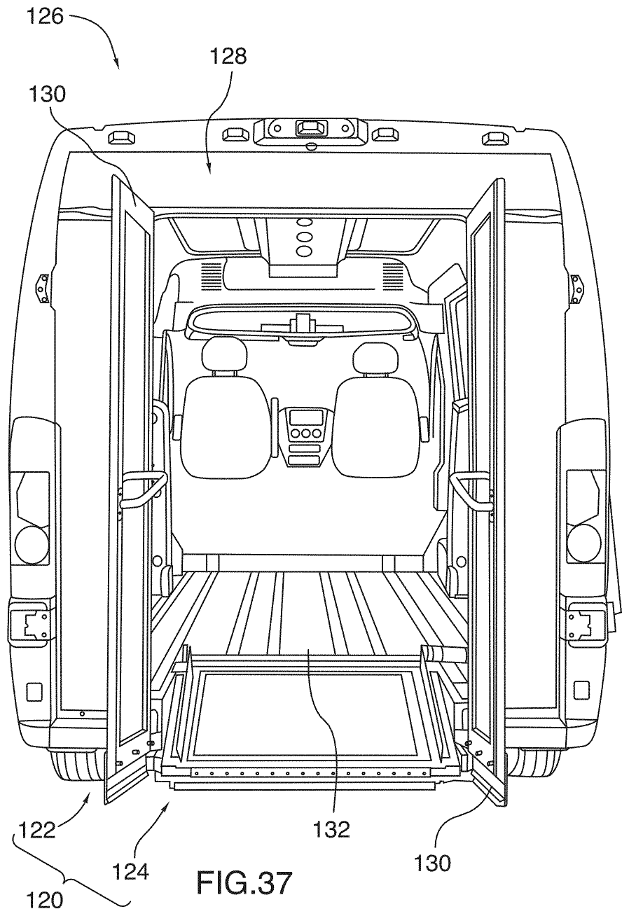

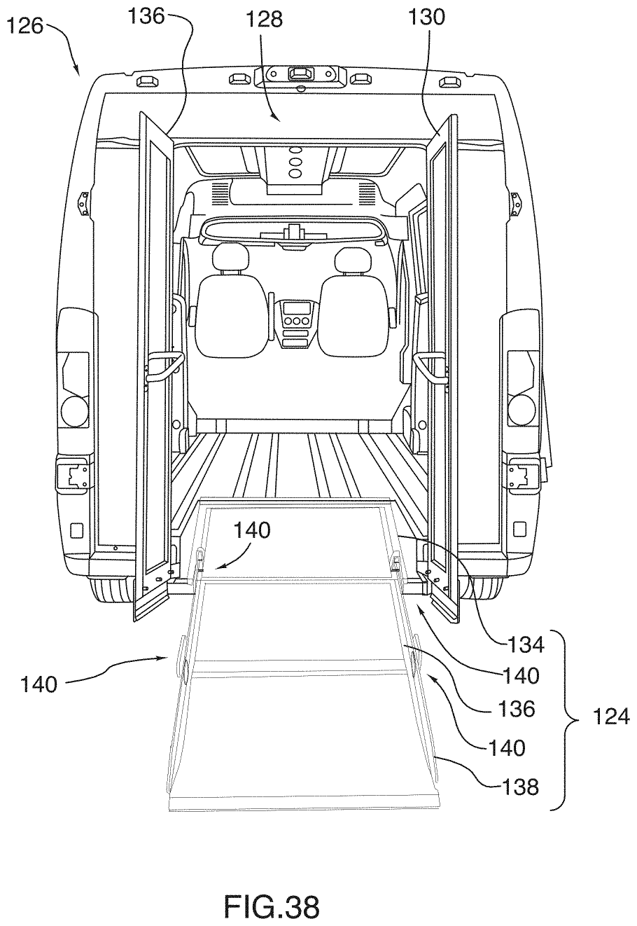

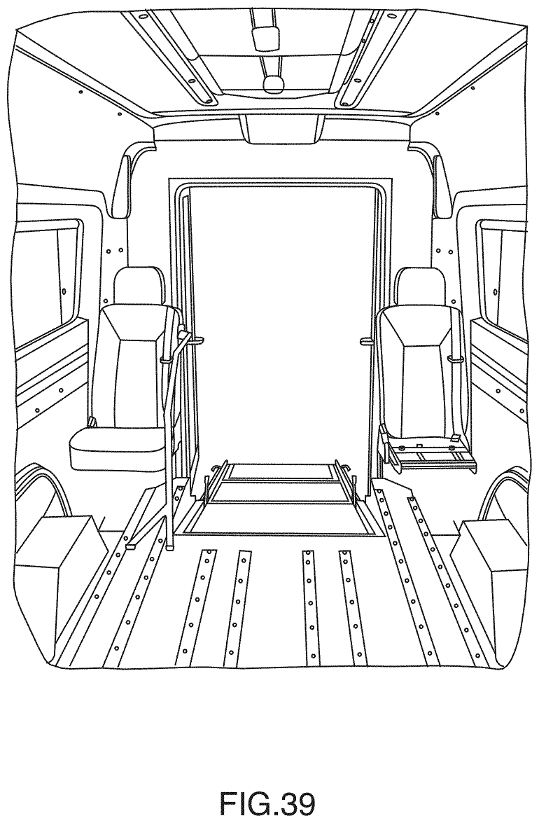

Ramp 124 is moveable between a folded configuration (FIG. 37), wherein all three segments 134, 136, 138, are stacked on top of one another in a Z-shape, and an extended configuration (FIG. 38), where all three segments 134, 136, 138 extend in end-to-end relation.

Ramp 124 illustrated is the BF3462Y-2 model of the RA300 Transit Ramp manufactured by BraunAbility® and is shown in FIGS. 18 and 19.

The BF3462Y-2 model has a usable width of approximately 34 inches, a usable length Cl of approximately 95 inches, a carrying capacity of 1,000 lbs and, in the folded configuration, is approximately 38 inches wide by 33 inches long.

In the embodiment illustrated, ramp 124 has a metal, such as aluminum, construction with a metal housing, such as stainless steel, with a welded box design to provide for rigidity. It also has a continuous slip-resistant surface, and a baked-on powder coating to provide for corrosion resistance. The frame design provides rigidity for ramp alignment and ramp operation. Ramp 124 has been tested to a minimum static load of 1980 pounds and has a 1000 pound rated capacity.

Power unit of ramp 124 uses a hydraulic pump module that uses a voltage of 12 VDC and a maximum current of 30 amps for automatically folding and unfolding ramp 124. Ramp power supply includes a self-contained 12 volt electric hydraulic system operating two bi-directional cylinders that do not require dependence on the vehicle's hydraulic systems. The hydraulic power pack system is of a modular design and the power operation of the hydraulic cylinders is a push-pull design. Ramp 124 has a gravity-down feature to prevent vehicle jacking upon deployment, and ramp pinching upon stowage. Ramp 124 also employs a pressure relief system to limit its ability to raise more than 50 pounds.

Ramp 124 further includes a manual back-up system for ensuring operation of ramp 124 in case of electrical failure. The back-up system includes means, such as hand grips, to manually stow and deploy ramp 124.

In the present embodiment, ramp pan 134 is positioned immediately adjacent doors 130 with the rear ramp hinge pivot a distance D1 of about 14.25″ above the ground and angled such that: (i) in the folded configuration, the ramp is disposed within the vehicle; and (ii) in the extended configuration, the ramp defines a smooth extension of the load floor that extends through entrance 128 to rest on a curb or ground that is exterior to vehicle 122.

While one embodiment of vehicle 122 is described, variations are possible.

For example, rather than a Ram Promaster®, vehicle 22 may be a Fiat Ducato, a Peugeot Boxer, a similar L4H2 (Length 4, Height 2) vehicle, such as a Ford Transit, and Mercedes Sprinter, or another vehicle with a GVWR (Gross Vehicle Weight Rating) between 8,000 lbs and 13,000 lbs that is commercially available on the market.

In other applications, vehicle 122 would have an interior height between 56 and 81 inches, and an interior width between 38 and 74 inches. The vehicle would also preferably have an internal volume between 250 and 500 cubic feet and a load floor height of at least 19 inches.

Rather than the BF3462Y-2 model of the Transit Ramp manufactured by BraunAbility®, ramp 124 may be a different ramp that can be folded into the vehicle and unfolded to extend outside the vehicle, so long as that ramp can accommodate and structurally support a handicapped individual in a wheelchair.

In that regard, rather than a ramp with dimensions of 38 inches by 33 inches long while folded, the usable width of ramp 124 may be 26 to 44 inches wide, and/or 27 to 40 inches long when folded. As well, in the extended configuration, the useable portion of ramp 124 may be 26 to 44 inches wide, and/or 30 to 120 inches long.

Rather than double leaf doors 130, vehicle 122 may involve a single leaf door, or a different door, so long as the doors do not interfere with the operation and storage of ramp 124 in either of its configurations.

As noted above, ramp pan 134 is entirely positioned within the envelope of the original (unmodified) vehicle. In an alternate embodiment, ramp may be secured such that a portion of ramp pan 134 extends outside of the original envelope. For example, the lower end of ramp pan 124 may extend past original rear of the vehicle.

To accommodate this variation, the entrance may be positioned generally the same distance from original envelope as ramp pan 124. Such a variation may allow for a larger interior usable space.

### Method

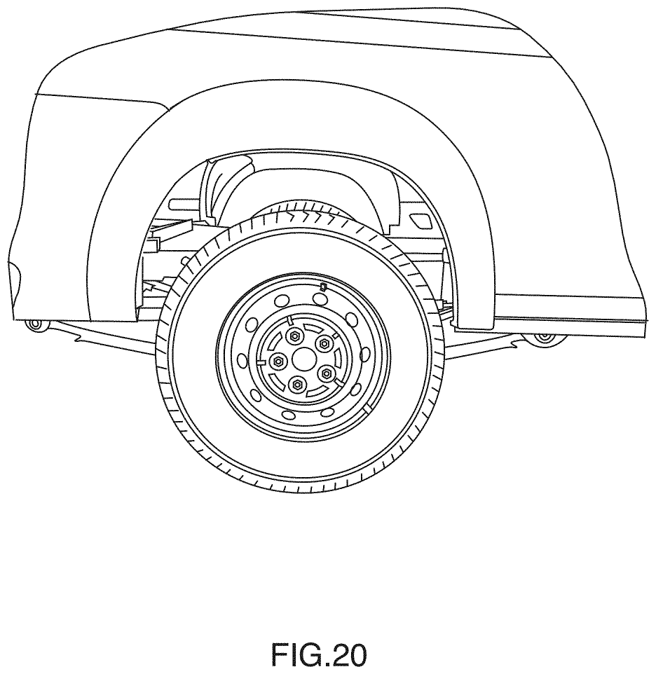

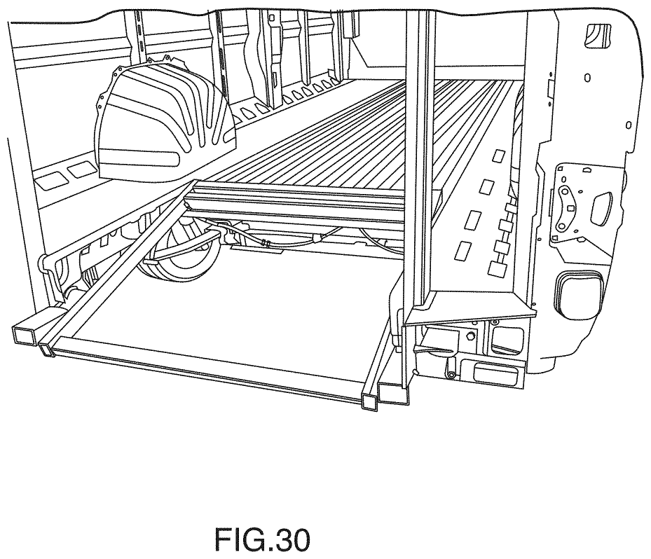

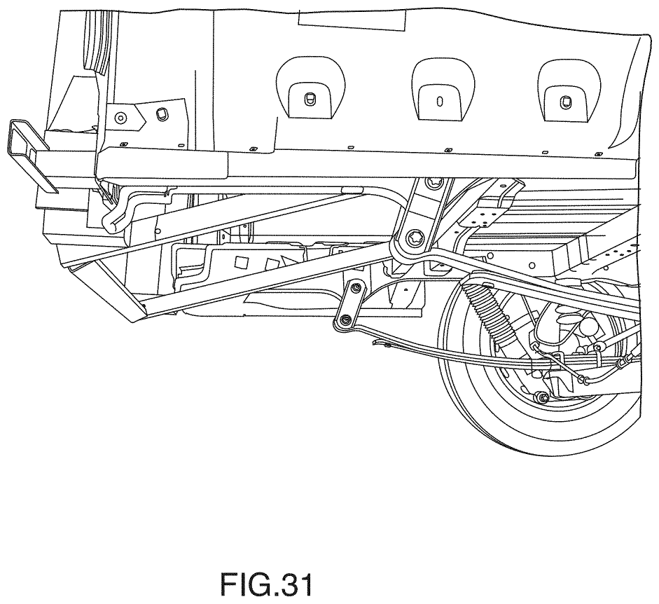

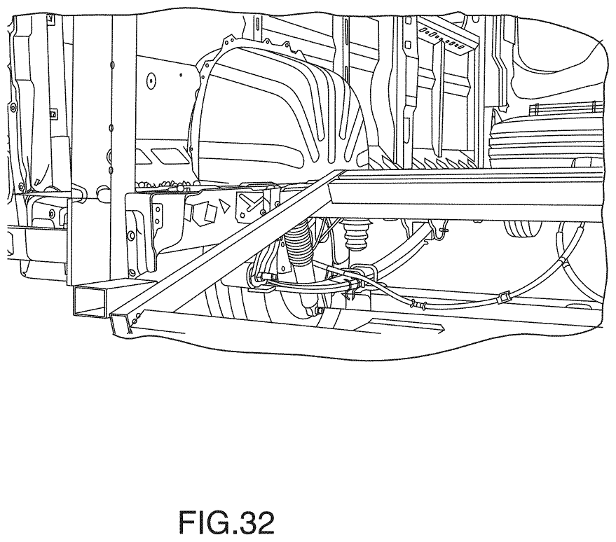

Referring to FIGS. 20-34, there is shown an example of a method of modifying a standard commercial vehicle, with a GVWR between 8,000 lbs and 13,000 lbs, into vehicle 122.

### Floor Lowering

As one part of the example method, portions of the rear fenders are removed, as shown in FIG. 20, as are the rear wheel wells (not shown).

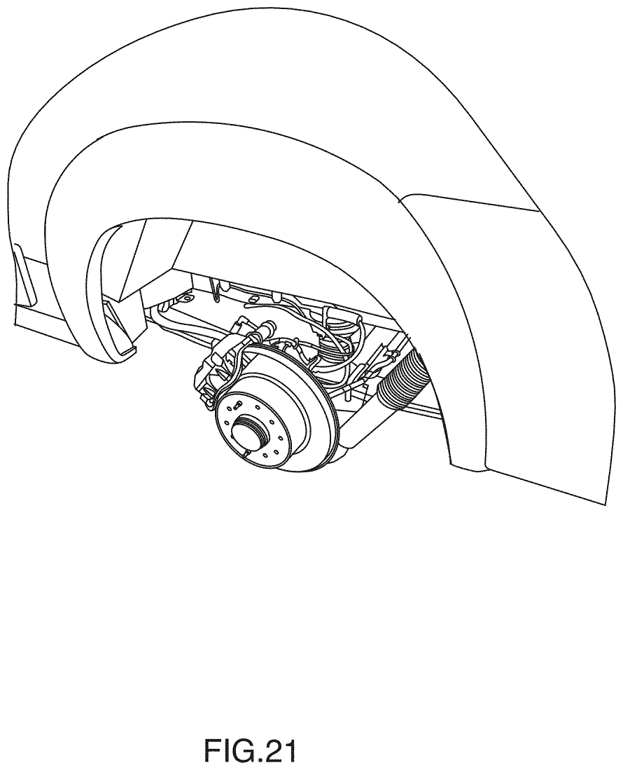

As another part, the rear wheels are removed, as indicated in FIG. 21

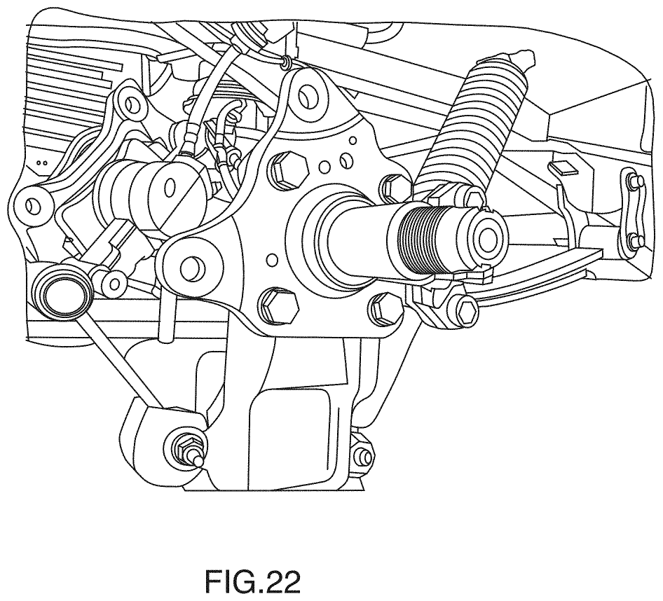

Thereafter, the wheel carriers are removed, as indicated in FIG. 22.

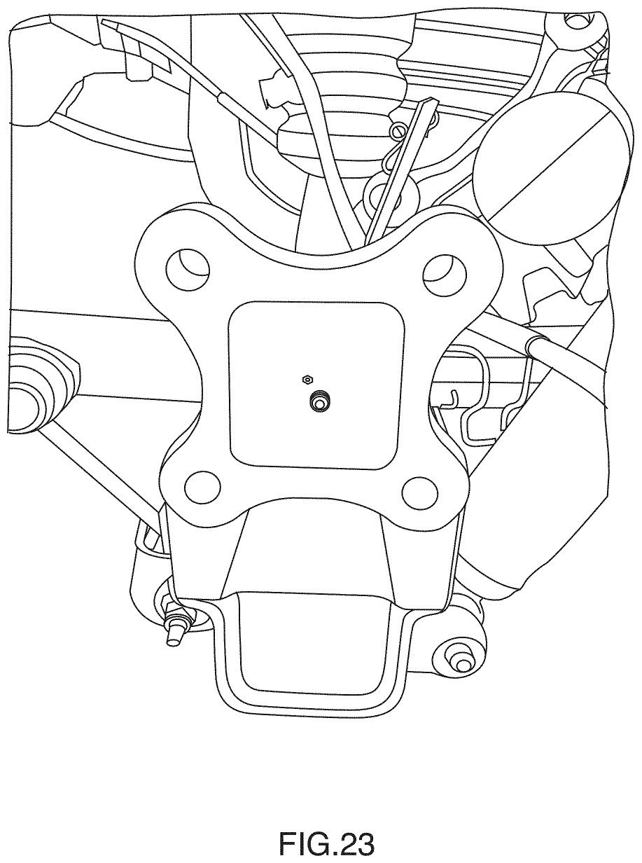

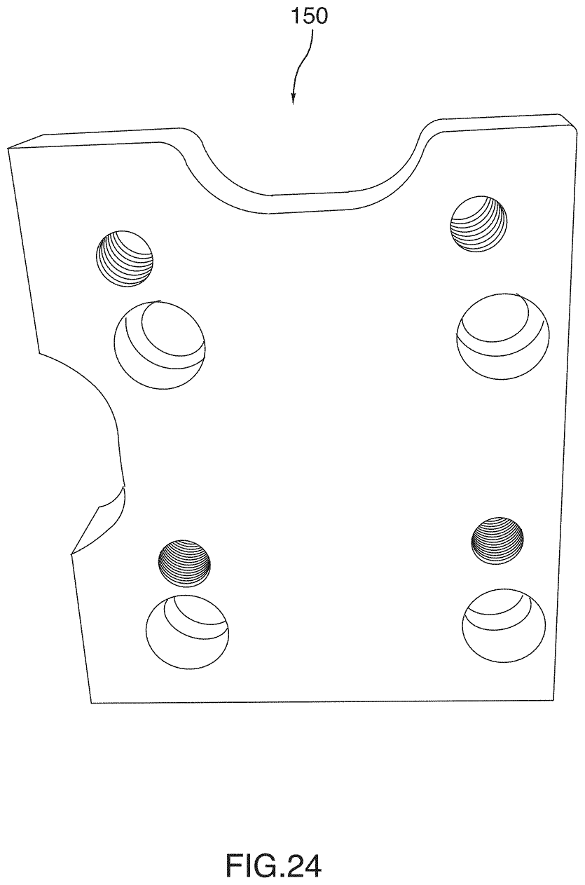

Thereafter, the spindles are removed, as indicated in FIG. 23, revealing the spindle supports.

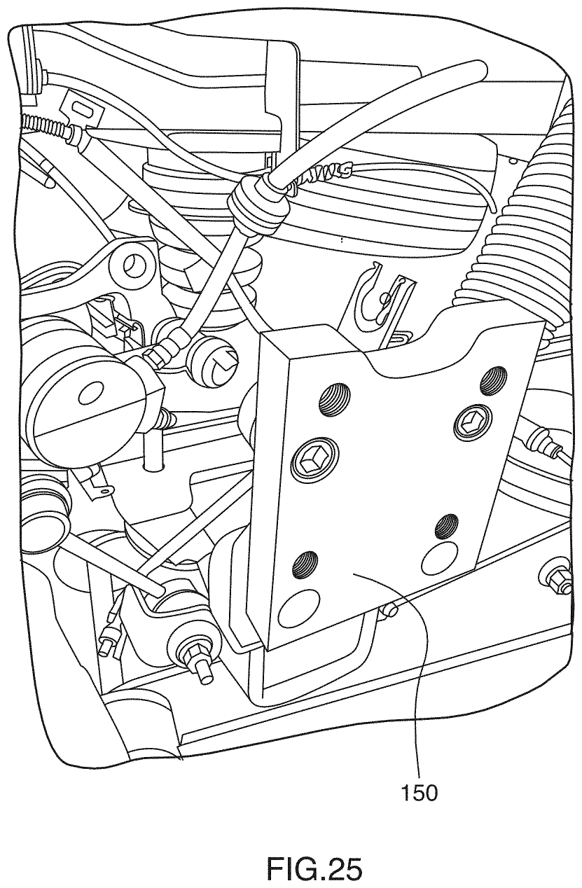

Thereafter, the spindle supports are removed and adapter plates 150, as shown in FIG. 24, are mounted to the axle brackets, as shown in FIG. 25.

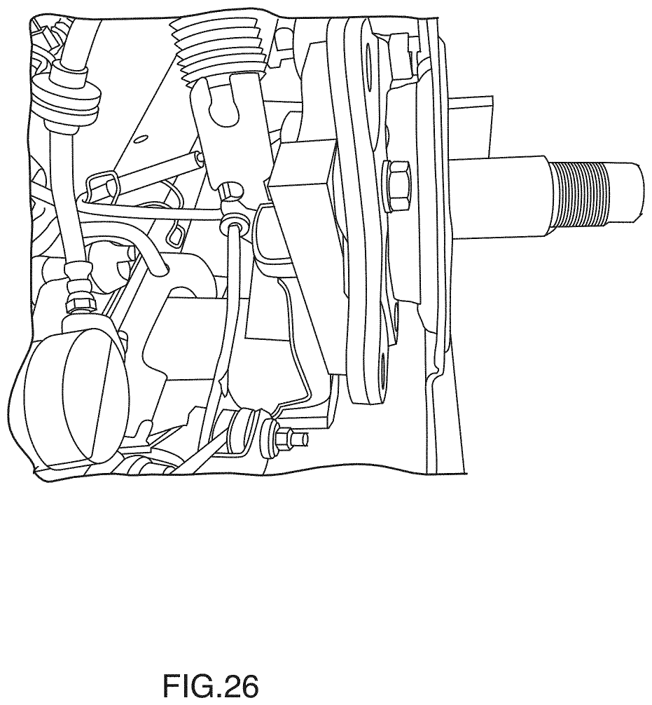

Thereafter, the spindle supports are mounted to the adapter plates and the spindles are mounted to the spindle supports, as shown in FIG. 26.

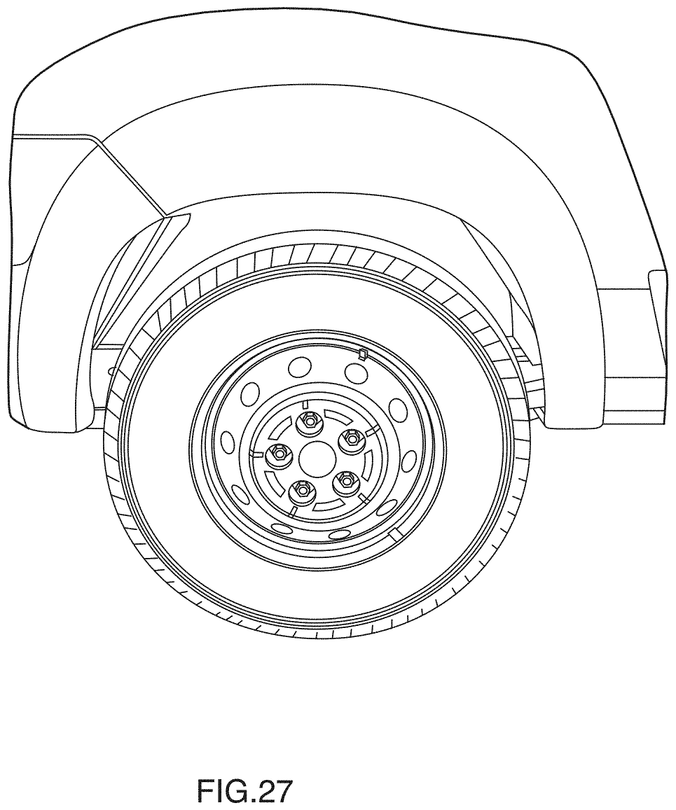

Finally, the wheels and fenders are replaced, as shown in FIG. 27.

This has the effect of lowering the vehicle's rear end by approximately 1″.

### Wheel Wells

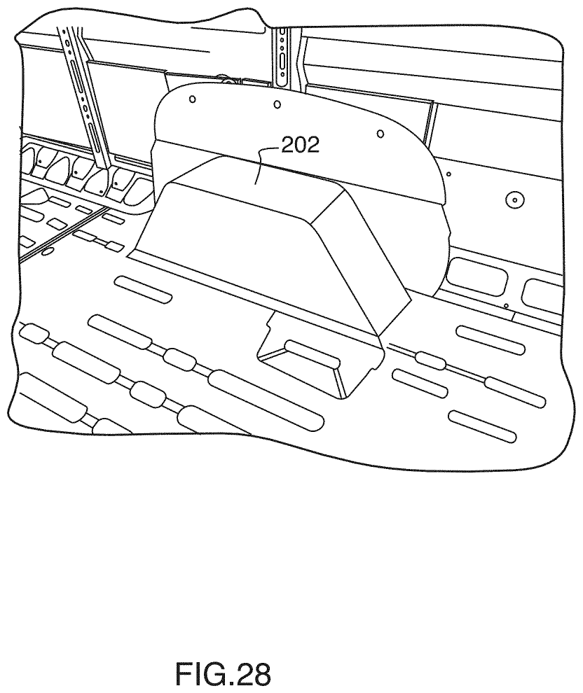

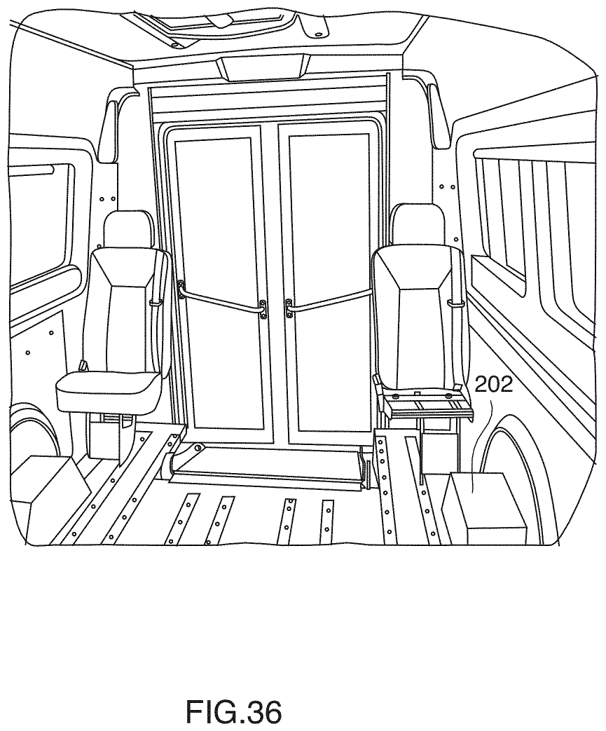

As another part of the method, new wheel wells 202 are constructed and installed, as shown in FIG. 28. This has the effect of increasing usable space, thereby permitting seats to be positioned in flanking relation to the rear entrance, as shown in FIG. 36.

### Rear Entry Modification Method

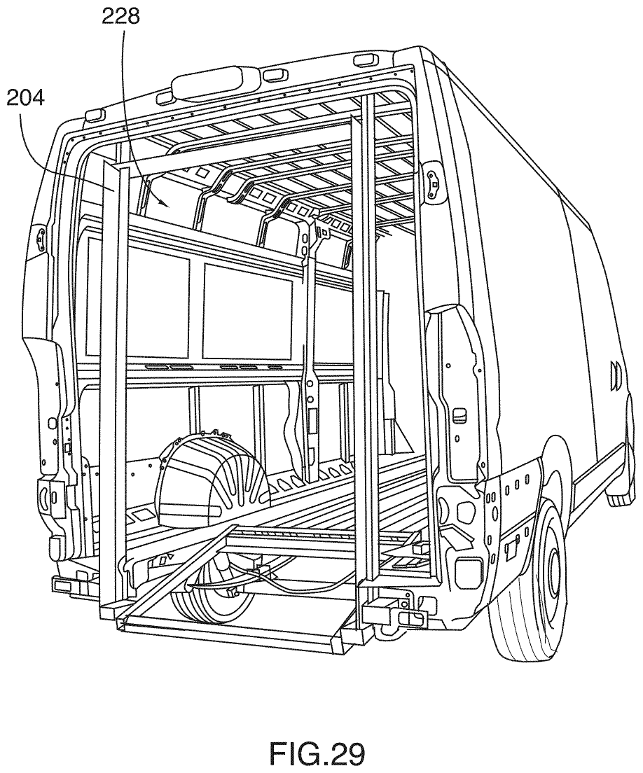

As a first step, the rear doors and a portion of the floor of vehicle is removed and a frame 204 defining rear entrance 228 is secured to the remainder of the vehicle, as shown in FIGS. 29-32.

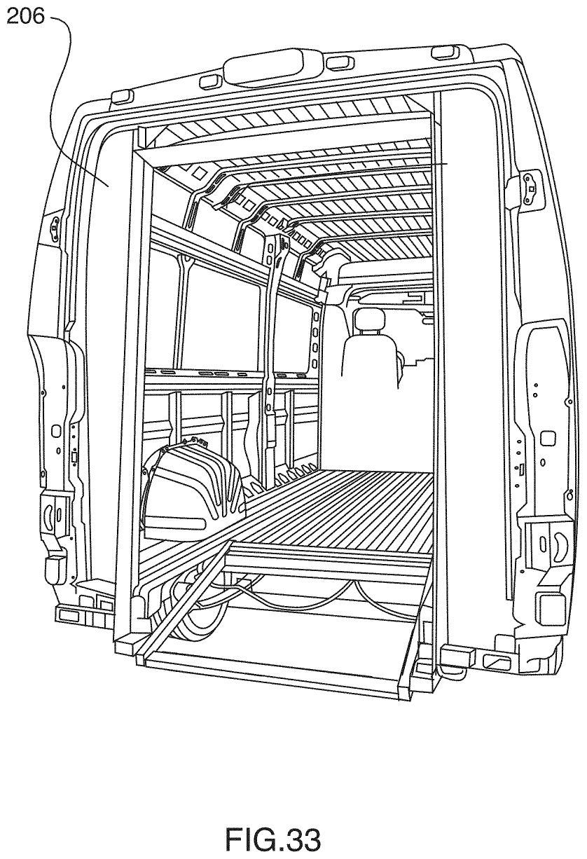

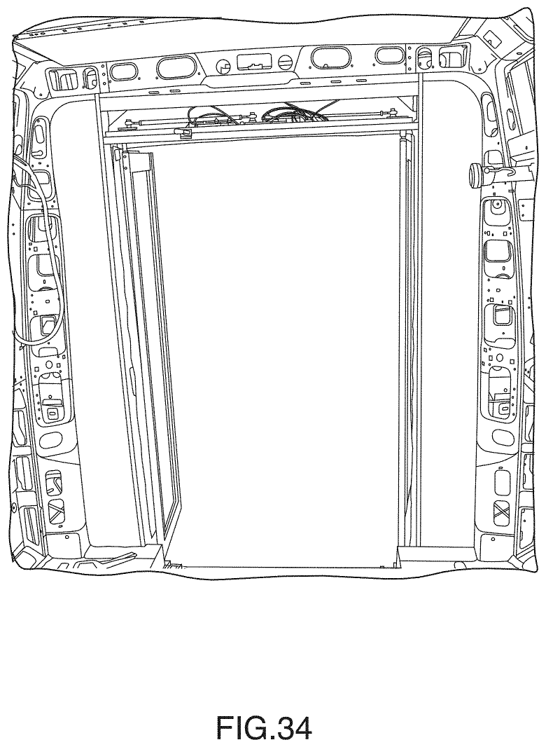

As another step, the gap between the frame and the vehicle is occluded with steel 206, to provide rigidity, as shown in FIGS. 33-34

Thereafter, ramp 124 and door leaf doors 130 are secured to the frame 204.

### Side Entry Sliding Ramp Embodiment

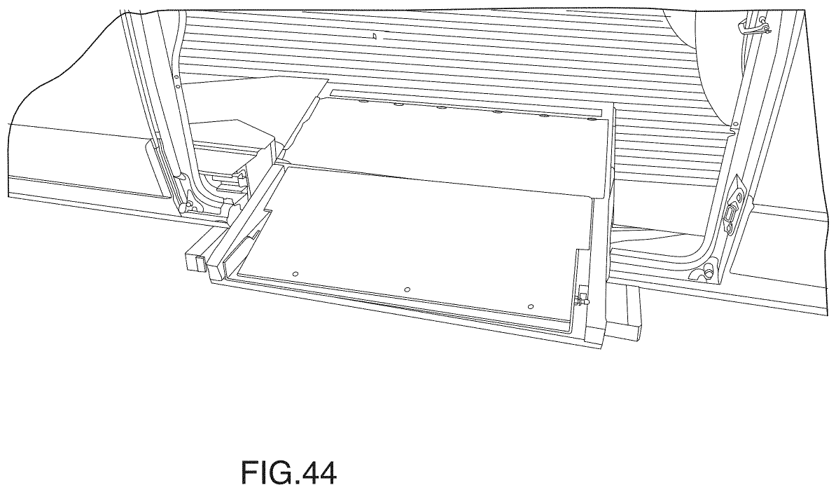

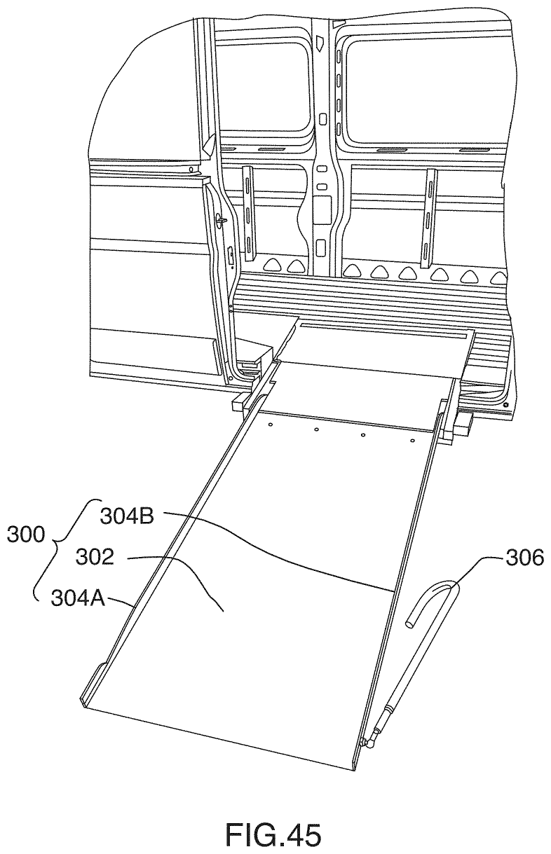

Yet another embodiment of the invention is shown in FIGS. 44 and 45.

In this embodiment, a body 300 defined by a planar base 302 and parallel rails 304A, 304B is provided, and is slidably mounted for movement in a channel (not shown) between an extended position, shown in FIG. 45, and a retracted position, shown in FIG. 44. Sliding movement is accommodated by a roller, not shown, mounted to one 304A of the rails, which rides in the channel, and by a handle 306, pivotally mounted to the end of rail 304B. Handle 306 allows for the weight of the body to be shifted to the roller for the aforementioned sliding movement.

When the body is in the retracted position, double leaf doors as previously described can be closed, to seal the passenger area; in the extended position, the body defines a ramp leading from the vehicle floor to the ground.

While specific embodiments are herein shown and described, variations are possible. Accordingly, the invention should be understood to be limited only by the accompanying claims, purposively construed.

1. An accessibility vehicle for use with a vehicle and configured to move and stop on a surface, the accessibility vehicle comprising:
a modified commercial vehicle having a side entrance and a floor; and
a bi-fold ramp module secured to the floor, the ramp module positioned such that:
in a folded configuration, the ramp module is substantially situated within the vehicle, and
in an extended configuration, the ramp module extends through the side entrance towards the surface to form a wheelchair ramp, the wheelchair ramp adapted for traverse in use by the wheelchair between the surface and the floor of the vehicle.

2. The accessibility vehicle of claim 1, further comprising double-leaf doors positioned to operatively cover the side entrance.

3. The accessibility vehicle of claim 1, wherein
the module comprises: a ramp pan secured to the floor, a first extension panel, and a second extension panel secured together with hinges; and
when the module is in the folded configuration, the ramp pan and the first and second extensions are substantially situated within the vehicle, and when the module is in the extended configuration, the first and second extensions collectively extend through the side entrance to form the wheelchair ramp.

4. The accessibility vehicle of claim 3, wherein the ramp pan is secured at a ramp angle to the floor, the ramp angle being about 9.5 degrees.

5. The accessibility vehicle of claim 3, having a dimensional ratio (d₁:d₂:d₃) of approximately 6:9:2, where
d₁ is an internal width of the vehicle,
d₂ is a length of the wheelchair ramp, and
d₃ a distance from the surface to the floor of the vehicle.

6. The accessibility vehicle of claim 5, wherein d₁:d₂:d₃ is approximately 62:95:21 inches.

7. The accessibility vehicle of claim 1, wherein the ramp is secured and is orientated at a non-perpendicular angle from a longitudinal axis of the floor.

8. The accessibility vehicle of claim 1, wherein the ramp module is secured at least 1.75 inches below the floor of the vehicle.

9. The accessibility vehicle of claim 1, comprising a transition pan secured between the ramp pan and the floor.

10. The accessibility vehicle of claim 1, wherein the accessibility vehicle has a Gross Vehicle Weight Rating between 8,000 lbs and 13,000 lbs.

11. A method of modifying a commercial vehicle into an accessibility vehicle with a bi-fold ramp module, the vehicle configured for use with a wheelchair, to move and stop on a surface and having a floor and sides, the ramp having a folded configuration and an extended configuration, the method comprising:
removing a portion of the side of the vehicle to create a side entrance;
removing a first section of the floor immediately adjacent the side entrance of the vehicle to create a first depression; and
installing the ramp module within the first depression, the ramp module positioned such that
in the folded configuration, the ramp module is substantially situated within the vehicle, and
in the extended configuration, the ramp module extends through the side entrance towards the surface to form a wheelchair ramp, the wheelchair ramp adapted for traverse in use by the wheelchair between the surface and the floor of the vehicle.

12. The method of claim 11, further comprising installing double-leaf doors to operatively cover the side entrance.

13. The method of claim 11, wherein the first section of the floor that is removed makes up about 14 percent of the floor.

14. The method of claim 11, wherein
the bi-fold ramp comprises a ramp pan, a first extension panel and a second extension panel secured together with hinges, and
installing the ramp comprises securing the ramp pan within the first depression in the floor such that
when the bi-fold ramp is in the folded configuration, the ramp pan and the first and second extensions are substantially situated within the vehicle, and
when the bi-fold ramp is in the extended configuration, the first and second extensions collectively extend through the side entrance to form the wheelchair ramp.

15. The method of claim 14, wherein the ramp pan is secured at a ramp angle to the floor, the ramp angle being about 9.5 degrees.

16. The method of claim 14, wherein the ramp pan is secured to the floor so as to create a dimensional ratio (d₁:d₂:d₃) of approximately 6:9:2 where
d₁ is an internal width of the vehicle,
d₂ is a length of the wheelchair ramp, and
d₃ a distance from the surface to the floor of the vehicle.

17. The method of claim 11, wherein installing the ramp comprises securing and orientating the ramp at a non-perpendicular angle from a longitudinal axis of the floor.

18. The method of claim 11, further comprising removing a second section of the floor immediately adjacent to the first depression to create a second opening or depression in the floor.

19. The method of claim 18, further comprising:
securing a transition pan within the second depression between the ramp pan and the floor.

20. The method of claim 11, wherein the commercial vehicle has a Gross Vehicle Weight Rating between 8,000 lbs and 13,000 lbs.

21. Apparatus comprising:
a vehicle having a rear entrance and a floor; and
a bi-fold ramp secured to the vehicle such that:
in a folded configuration, the ramp is situated within the vehicle, and
in an extended configuration, the ramp extends through the rear entrance to rest on a curb or ground exterior to the vehicle.

22. A method for use with a vehicle and a bi-fold ramp, the vehicle having a floor and a rear, the ramp having a folded configuration and an extended configuration, the method comprising:
constructing a rear entrance in the rear of the vehicle;
removing a section of the floor immediately adjacent the rear of the vehicle to create a void; and
installing the ramp within the void in the floor such that:
in the folded configuration, the ramp is situated within the vehicle, and
in the extended configuration, the ramp extends through the rear entrance to rest on a curb or ground exterior of the vehicle.
